(19) United States
(12) Patent Application Publication
(10) Pub. No.: US 2015/0163115 A1
(43) Pub. Date: Jun. 11, 2015

(54) METHOD OF MEASURING NETWORK TRAVERSAL TIME WHEN SETTING UP TCP CONNECTIONS

(71) Applicant: INFOVISTA SA, Les Ulis (FR)

(72) Inventors: Thierry Martin, Savonnieres (FR); Eric Jonot, Verezt (FR); Nicolas Neel, Artannes Sur Indre (FR); Didier Jean, Sorigny (FR)

(21) Appl. No.: 14/412,577

(22) PCT Filed: Jun. 21, 2013
(86) PCT No.: PCT/EP2013/063061

§ 371 Date: Jan. 2, 2015

(30) Foreign Application Priority Data
Jul. 5, 2012 (FR) 1256453

(51) Int. Cl. H04L 12/26

(52) U.S. Cl. CPC H04L 43/0864

(57) ABSTRACT

A method of measuring traversal time at a point of a network when setting up TCP (Transmission Control Protocol) connections, using recordings carried out according to a network protocol used to collect information on IP traffic, such as Netflow, the recordings including (i) a first recording generated by the synchronization request/response at this point of the network and (ii) the use of a field relating to a start instant (“StartTime”) of the first recording so as to date-stamp the synchronization request/response at this point of the network.

### TECHNICAL FIELD

The present invention relates to the use of a method of measuring network traversal time when setting up TCP connections, based on Netflow technology.

### STATE OF THE PRIOR ART

Within the context of network monitoring, it may be a complex matter to discover an element that is responsible for impaired performance.

One of the problems encountered is to be able to determine and explain frame transit times during the traversal of a network in the context of setting up TCP (transmission control protocol) connections, in order if possible to pinpoint a specific part of the configuration monitored.

Installing DPI (deep packet inspection) probes at several points of the network can provide a solution. However, at least two constraints run counter to this solution. On the one hand a deployment of this kind is complex and costly. On the other hand, simply timestamping identical frames at different points of the network with a view to measuring the traversal time imposes a strict time synchronization between the probes that is sometimes difficult to maintain and the accuracy of which is not always adequate.

Netflow is a network protocol developed by the company CISCO and used for collecting information on IP traffic. Different network devices, in particular switches and routers, are capable of exporting Netflow information for the purposes of network monitoring.

Devices supporting Netflow collect statistics relating to the IP traffic on the interfaces where Netflow has been activated. These statistics are then exported in the form of Netflow records to one or more Netflow collectors.

The Netflow collector carries out the analysis of the statistics collected in this way.

The Netflow statistics relate to flows. A flow is defined as a unidirectional sequence of packets sharing the following values:

1. Interface Ingress (SNMP ifIndex)

2. Source IP address,

3. Destination IP address

4. IP Protocol

5. Source port for UDP or TCP, 0 for the other protocols,

6. Destination port for UDP or TCP, 0 for the other protocols,

7. IP Type of Service

In version 5 of the Netflow protocol, the statistics are sent in the form of UDP datagrams, comprising a header and netflow records.

The following tables may be mentioned (ref: http://www.cisco.com/en/US/docs/net mgmt/netflow collection engine/3.6/user/guide/format.html) giving the detailed format of the Netflow packets.

TABLE 1
header of Netflow Version 5

| Bytes | Contents | Description |
|---|---|---|
| 0-1 | version | NetFlow export format version number |
| 2-3 | count | Number of flows exported in this packet (1- |
| | | 30) |
| 4-7 | SysUptime | Current time in milliseconds since the |
| | | export device booted |
| 8-11 | unix_secs | Current count of seconds since 0000 UTC |
| | | 1970 |
| 12-15 | unix_nsecs | Residual nanoseconds since 0000 UTC 1970 |
| 16-19 | flow_sequence | Sequence counter of total flows seen |
| 20 | engine_type | Type of flow-switching engine |
| 21 | engine_id | Slot number of the flow-switching engine |
| 22-23 | [symbol] | [symbol] |
| | (NDLR: pad) | [symbol] |
| | | [symbol] |
| | | [symbol] |
| | | [symbol] |

TABLE 2
Format of the Netflow Version 5 record

| Bytes | Contents | Description |
|---|---|---|
| 0-3 | srcaddr | Source IP address |
| 4-7 | dstaddr | Destination IP address |
| 8-11 | nexthop | IP address of next hop router |
| 12-13 | input | SNMP index of input interface |
| 14-15 | output | SNMP index of output interface |
| 16-19 | dPkts | Packets in the flow |
| 20-23 | dOctets | Total number of Layer 3 bytes in the packets of the |
| | | flow |
| 24-27 | First | SysUptime at start of flow |
| 28-31 | Last | SysUptime at the time the last packet of the flow was |
| | | received |
| 32-33 | srcport | TCP/UDP source port number or equivalent |
| 34-35 | dstport | TCP/UDP destination port number or equivalent |
| 36 | pad1 | Unused (zero) bytes |
| 37 | tcp_flags | Cumulative OR of TCP flags |
| 38 | prot | IP protocol type (for example, TCP = 6; UDP = 17) |
| 39 | tos | IP type of service (ToS) |
| 40-41 | src_as | Autonomous system number of the source, either |
| | | origin or peer |
| 42-43 | dst_as | Autonomous system number of the destination, either |
| | | origin or peer |
| 44 | src_mask | Source address prefix mask bits |
| 45 | dst_mask | Destination address prefix mask bits |
| 46-47 | pad2 | Unused (zero) bytes |

The following paragraphs relate more particularly to the fields “First” (also called “StartTime” in the screenshots hereinafter) and “tcp_flags” (“TCP Flags”).

The “First” field corresponds to the “sysuptime” of the Netflow device at the start of the flow; in other words this is the timestamp of the first packet accounted for in the Netflow record. It is noteworthy that the accuracy of this value is of the order of a millisecond.

The “tcp_flags” field is a cumulative OR of all the tcp flag fields of the packets accounted for.

A single direction of TCP communication can be the subject of several Netflow records, in particular if the TCP communication is long (see the Netflow flow expiry criteria).

For a TCP connection, with reference to FIG. 1, the synchronization request delay (SYN delay) corresponds to the time taken between:
the sending of a (SYN) synchronization request packet by a TCP client 102
and the sending by a server 104 of the (SYN-ACK) TCP acknowledgement response packet.

The measured value varies depending on the measurement point; the greater the physical distance from the server, the larger is the value.

For a measurement point situated very close to the server, the SYN/SYN-ACK delay can be considered as the reflection of the state of health of the server, since it is the reaction time thereof which principally impacts on the value.

For a measurement point placed close to the client, the measurement accounts for the network traversal time added to the response time of the server. This measurement allows a potential performance problem on the TCP communication to be discovered without making it possible to identify to what extent this can be attributed to the quality of the network or to the state of the TCP server.

With reference to FIG. 2, a TCP connection between a web client 202 having an IP address 10.105.5.67 and a web server 204 having an IP address 10.1.12.38 will now be considered.

On the Web Client station 202, an http request to the Web Server 204 is initiated. On the network, this results in a TCP connection.

The http request is routed to the Web Server 204 by a router C 206 on the Web Client 202 side, a network of www internet type, 208, and a router S, 210, on the Web Server 204 side. The router C 206 has the IP address 89.87.185.102. The router S 210 has the IP address 89.87.185.103.

### Investigation of Traffic Capture on the Router C

FIG. 3 is a traffic capture taken at the router C 206.

It shows:
in line 1 the TCP synchronization request (SYN) originating from the client,
and in line 2 the response (SYN-ACK) from the server.
   The column “Time” indicates the time elapsed between each frame. Between the SYN and the SYN, ACK (line 1, line 2) the measured time is 24 ms (0.0024131 s).

With reference to FIG. 4, the capture takes place at the “server side” router S 210. On this occasion, the time between the SYN and the SYN-ACK (line 1, line 2), the measured time, is less than 1 ms (0.000041 s).

### SUMMARY

The way in which the TCP synchronization request delay can be broken down is shown in the diagram in FIG. 5.

FIG. 5 comprises the elements of FIG. 2. In addition, the instants t1, t2, t3 and t4 which will now be described are represented in FIG. 5.

The instant t1 is the instant the packet SYN passes through the router C 206.

The instant t2 is the instant the packet SYN passes through the router S 210, after having traversed the www network 208.

The instant t3 is the instant the packet SYN-ACK passes through the router S 210.

The instant t4 is the instant the packet SYN-ACK passes through the router C 206, after having traversed the www network 208.

The delay measured at the router S corresponds to the value t3-t2 (<1 ms).

The capture of the same connection at the router C (close to the client) shows a delay of 24 ms (t4-t1).

I.e.: D=(t4−t1)−(t3−t2)

D corresponds to the part of the delay that can be attributed to the transmission time (outward and return) between routers C and S, therefore that which takes place in the “www” cloud. These two measurement points therefore make it possible to specify the components of a transmission time. It is important to note that there is no need for routers C and S to be time-synchronized.

In a normal context, permanent activation of capture on a router is not possible.

The principal purpose of the present invention is to propose a timestamping method which makes it possible to easily obtain information on the flows traversing the router in question, and to determine, for a TCP connection,

the timestamping of the synchronization request and acknowledgement frames and deduce therefrom the synchronization request delay.

A further purpose is to propose such a method which is less complex and more cost-effective than the current methods, which is not invasive and does not impose a strict time synchronization between probes implementing this method.

### DISCLOSURE OF THE INVENTION

This objective is achieved with a method of measuring traversal time at a point of a network when setting up TCP (transmission control protocol) connections, using recordings made according to a network protocol used for collecting information on IP traffic, such as Netflow, said recordings comprising (i) a first recording generated by said synchronization request/response at this point of the network and (ii) using a field relating to a startup instant (“StartTime”) of said first recording in order to timestamp said synchronization request/response at this point of the network.

Determining the first recording generated by the synchronization request/response can advantageously comprise reading the value of a “TCP flags” field within a recording, and in that the first recording is the one in which the SYN flag of the “TCP flags” field is positioned at “true”.

The timestamping method according to the invention can comprise moreover determining a delay between two devices providing recording data according to the network protocol such as Netflow.

This method can be implemented at several points of the network in order to determine a part of the delay that can be attributed to a segment of the network.

It can exploit a first recording relating to an information flow between a client and a server, and a second recording relating to the information flow between the server and the client.

The method according to the invention can comprise moreover a step for verifying that a “StartTime” field within a recording corresponds to the first packet of one direction of the communication, this “StartTime” field then corresponding to the time of capture of the SYN or SYN-ACK packet of the communication.

It can moreover comprise a calculation of TCP synchronization request delay at a measurement point represented by an information collection device.

The synchronization request delay calculation can advantageously implement two recordings originating from a single router, relating respectively to one direction of a single TCP communication and responding to criteria making it possible to determine the timestamping of SYN and SYN-ACK packets.

The synchronization request delay can thus be performed by determining the absolute value of a time difference of SYN and SYN-ACK packets:

D=abs(Tsynack−Tsyn)

where Tsyn is the time of passage of the SYN packet, and Tsynack is the time of passage of the SYN-ACK packet.

The method according to the invention can moreover comprise a calculation of the synchronization request transmission delay that can be attributed to the hop between a device C and a device S.

The synchronization request transmission delay can advantageously be calculated as an absolute value of the difference between a measurement of the synchronization request transmission delay determined at the device C and a measurement of the synchronization request transmission delay determined at the device S.

The present invention thus relies on the fact of exploiting recordings such as “netflow records” in the v5 (or similar) format,—which are normally intended to provide information of a quantitative nature —, so as to generate a qualitative indicator, in this case the SYN/SYN-ACK.

The method according to the invention thus enables:
A. timestamping of a synchronization request (or response) in the context of a TCP connection by analyzing the data provided by Netflow,
B. on the basis of [A], calculating a TCP synchronization request delay at the measurement point where the Netflow information relating to the TCP connection is collected,
on the basis of [B] and by carrying out this type of measurement at several points of the network, determining the delay that can be attributed to each segment.

The timestamping method according to the invention thus offers a simple technical response to these problems that is exploitable over the long term, for the following reasons:
it relies on Netflow technology or any other equivalent technology for collecting information on a network, that is frequently available on the network devices already in place,
it does not require synchronization between the devices acting as measurement point,
the accuracy of the measurements is of the order of a millisecond,
it can be installed for permanent monitoring of the evolution of time measurement.

By exploiting this method of measuring synchronization request delay, it becomes possible to break down this time in order to see the impact of each part of the network traversed.

### DESCRIPTION OF THE FIGURES AND EMBODIMENTS

Other advantages and features of the invention will become apparent on reading the detailed description of implementations and of an embodiment which is in no way limitative, and from the following attached drawings:

FIG. 1 shows a SYN/SYN-ACK delay,

FIG. 2 shows network elements involved in the case study,

FIG. 3 shows a screenshot of traffic on the router C,

FIG. 4 shows a screenshot of traffic on the router S,

FIG. 5 shows a breakdown of the TCP synchronization request delay,

FIG. 6 represents recording details (Netflow records) emitted by the router C,

FIG. 7 shows a screenshot of the frames on which are based the recordings (Netflow records), on the router C,

FIG. 8 represents details of the recordings (Netflow records) emitted by the router S, and

FIG. 9 shows a screenshot of the frames on which are based the recordings (Netflow records) on the router S.

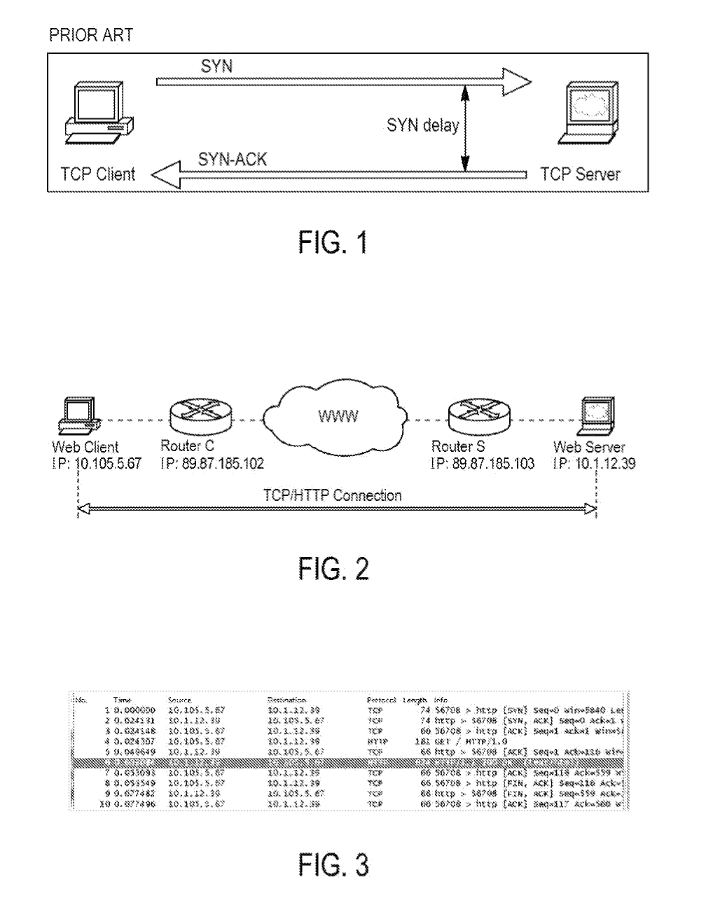

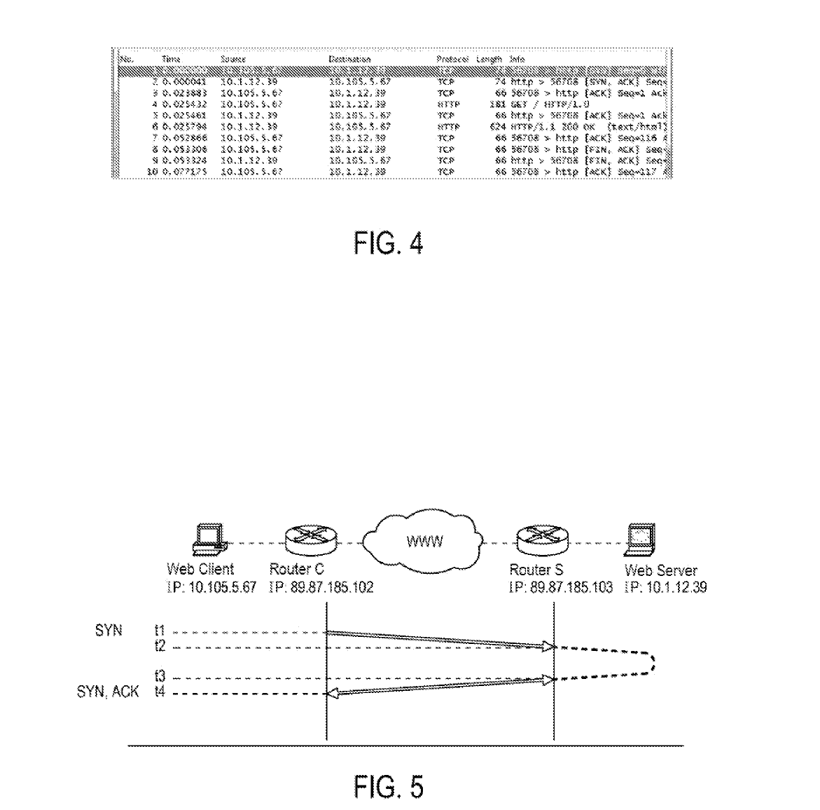

Determination of the traversal time by implementing the method according to the invention at several collection points will now be described in detail, with reference to the abovementioned figures.

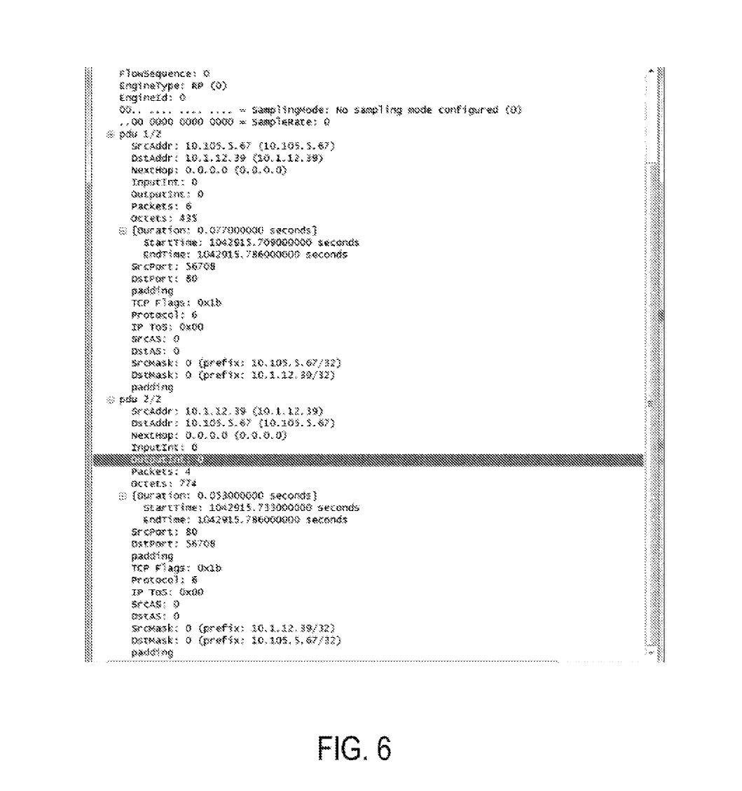

In the context of a TCP communication, if a “netflow” collection is activated on the router C, then the communication is posted to two Netflow recordings as follows, with reference to FIG. 6.

Recording 1 relates to the flow between the client and the server, while recording 2 relates to the flow between the server and the client.

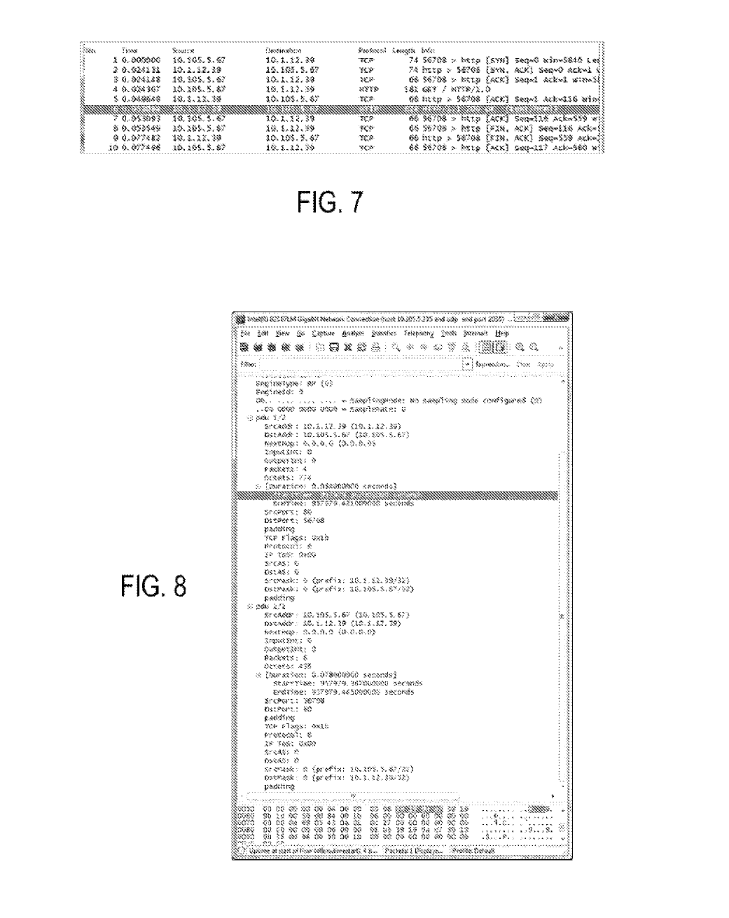

By comparison with the previous capture, it is possible to verify the statistics provided in the recordings (Netflow records), for example 6 packets exchanged in one direction and 4 in the other, with reference to FIG. 7.

Timestamping of the SYN and SYN ACK packets based on recordings (Netflow records) will now be described. A priori, the content of the recordings (Netflow records) emitted by the router C and represented in FIG. 6 does not give this indication natively.

It should be noted that one TCP direction of communication can be posted in the form of several recordings (Netflow records), in particular if a flow expiry criterion triggers the emission of the flow before the end of the communication. In other words, the “StartTime” field does not necessarily give the timestamp of the first packet for one direction of communication.

Thus in order to be sure that the “StartTime” field corresponds to the first packet of one direction of the communication, it is necessary to verify that the “TCP flags” field (a cumulative OR of all the TCP flags seen in the posted packets) comprises a “SYN” bit positioned at true.

If the preceding condition is verified, the “StartTime” field corresponds to the time of capture of the SYN or SYN-ACK packet of the communication.

An export of a Netflow recording, FIG. 6, will now be considered, by comparison with the associated screenshot, FIG. 7.

In recordings 1 and 2, the “TCP flags” field is positioned at 0x1b, which means that the flag SYN is in place. The “StartTime” fields can therefore be exploited as the time of passage of the TCP synchronization requests and responses.

By taking the absolute value of the difference in the “StartTimes” of the Netflow records, it is found that:

DC=abs(1042915.733−1042915.709)=0.024

i.e. 24 ms, which corresponds to the elapsed time shown in the associated screenshot (time difference between frames 1 and 2) in FIG. 7.

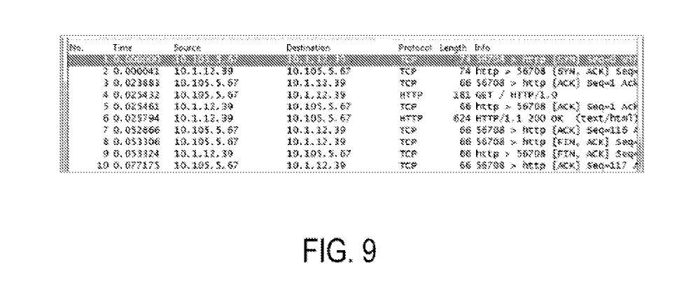

The same verification is carried out on the capture and the (Netflow) recordings seen on the router S (close to the server). The relative screen captures are shown in FIGS. 8 and 9.

According to analysis of the recordings (Netflow records), the measured delay is 0 ms, which confirms the capture (the time of 0.041 ms is negligible in this context).

To the extent that it is possible, using recording data (Netflow), to determine the TCP synchronization request and response times and to deduce therefrom the TCP synchronization request delay, and providing that this measurement is carried out at several points of the network, then the technique based on network captures can be transposed to a context using the Netflow protocol.

The feasibility of using the Netflow collection protocol to specify the components of a network transmission time is therefore demonstrated.

Considering a recording (of Netflow v5 type or similar) relating to one direction of TCP communication, the timestamp field of the start of the “First” flow (see Table 2: Format of the Netflow Version 5 record) can be interpreted as the time of passage of a TCP packet having the SYN flag in place, if the TCP flags field of the same record contains the “SYN” bit positioned at true.

Indeed, a TCP communication must begin by emitting TCP packets with the “SYN” flag in place, emitted initially by the client (TCP synchronization request) or emitted by the TCP server (acknowledgement of synchronization request).

The time indicator contained in a Netflow record corresponds to the time of the first packet accounted for in the record.

The following are noted:
Tsyn the time of passage of the SYN packet,
Tsynack the time of passage of the SYN-ACK packet.

A TCP synchronization delay calculation in the context of the timestamping method according to the invention will now be described.

Two Netflow records are assumed, originating from a single router, relating respectively to one direction of a single TCP communication and responding to criteria making it possible to determine the timestamping of SYN and SYN-ACK packets (as described in the preceding paragraph).

It is possible to determine the TCP synchronization request delay at the measurement point represented by the (Netflow) collection device by taking the absolute value of the difference in the times of SYN and SYN-ACK packets.

If D is the synchronization request delay.

D=abs(Tsynack−Tsyn)

A calculation of the point-to-point transmission delay of a TCP synchronization request will now be described.

Two devices C and S are assumed, exporting recordings (Netflow records) relating to a single communication, to which is applied the method of calculating a TCP synchronization request delay seen previously.

The synchronization request transmission delay that can be attributed to the hop between device C and device S can be calculated by taking the absolute value of the difference between the two measurements for calculation of TCP synchronization request delays.

Dc and Ds are assumed to be the synchronization request transmission delays determined respectively at devices C and S; with Dcs the synchronization request transmission delay that can be attributed to the hop between device C and device S.

Dcs=abs(Dc−Ds)

Of course, the invention is not limited to the examples which have just been described and numerous adjustments can be made to these examples without exceeding the scope of the invention. In particular, it is not limited to the Netflow protocol only but can implement other information collection protocols on networks having equivalent functions and/or field structures.

1. A method of measuring traversal time at a point of a network when setting up TCP connections, comprising: using recordings carried out according to a network protocol used for collecting information on the IP traffic, such as Netflow, said recordings comprising (i) a first recording generated by said synchronization request/response at this point of the network and (ii) using a field relating to a startup instant (“StartTime”) of said first recording in order to timestamp said synchronization request/response at this point of the network.

2. The method according to claim 1, characterized in that determining the first recording generated by the synchronization request/response comprises reading the value of a “TCP flags” field within a recording, and in that said first recording is the one in which the SYN flag of the “TCP flags” field is positioned at “true”.

3. The method according to claim 1, characterized in that it also comprises determining a delay between two devices supplying recording data according to the network protocol such as Netflow.

4. The method according to claim 1, characterized in that it is implemented at several points of the network in order to determine a part of the delay that can be attributed to a segment of said network.

5. The method according to claim 1, characterized in that it implements a first recording relating to an information flow between a client and a server, and a second recording relating to the information flow between the server and the client.

6. The method according to claim 1, characterized in that it also comprises a step for verifying that a “StartTime” field within a recording corresponds to the first packet of one direction of the communication, said “StartTime” field then corresponding to the time of capture of the SYN or SYN-ACK packet of the communication.

7. The method according to claim 1, characterized in that it also comprises a calculation of the TCP synchronization request delay at a measurement point represented by an information collection device.

8. The method according to claim 7, characterized in that the synchronization request delay calculation implements two recordings originating from a single router, relating respectively to one direction of a single TCP communication and responding to criteria making it possible to determine the timestamping of SYN and SYN-ACK packets.

9. The method according to claim 8, characterized in that the synchronization request delay is carried out by determining the absolute value of a difference between the times of SYN and SYN-ACK packets:
D=abs(Tsynack−Tsyn)
where Tsyn is the time of passage of the SYN packet, and Tsynack is the time of passage of the SYN-ACK packet.

10. The method according to claim 1, characterized in that it also comprises a calculation of the synchronization request transmission delay that can be attributed to the hop between a device C and a device S.

11. The method according to claim 10, characterized in that the synchronization request transmission delay is calculated as an absolute value of the difference between a measurement of the synchronization request transmission delay determined at the device C and a measurement of the synchronization request transmission delay determined at the device S.
